(19) United States
(12) Patent Application Publication
(10) Pub. No.: US 2006/0206495 A1
(43) Pub. Date: Sep. 14, 2006

(54) Method and apparatus for grouping content items

(76) Inventors: Johan Sebastiaan Henri Van Gageldonk, Eindhoven (NL); Robert Jochemsen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/551,969

(22) PCT Filed: Mar. 29, 2004
(86) PCT No.: PCT/IB04/50353

§ 371 Date: Oct. 5, 2005

(30) Foreign Application Priority Data
Apr. 7, 2003 (EP) 0310912.9

(51) Int. Cl. G06F 17/00

(52) U.S. Cl. 707/100

(57) ABSTRACT

The invention relates to a system for grouping content items. A consumer equipment or computer (100) comprises a grouping principle processor (109) that determines a content item grouping principle used by a user to group content items such as music files, video files or email. The content item grouping principle is determined in response to a grouping category scheme, such as a folder structure used to store content items. The apparatus (100) further comprises a classification characteristic processor (113) for determining a classification characteristic of a new content item. For example the classification characteristic may relate to an artist of a music file and the content item grouping principle may comprise a list of folders which comprise music files associated with specific artists. The apparatus (100) additionally comprises a grouping processor (115) for grouping the first content item with other content items by comparing the determined classification characteristic with the information of the content item grouping principle.

The invention relates to a method and apparatus for grouping content items such as audio files, video clips and emails.

In recent years, the accessibility to, and provision of, information and content, such as TV programs, video clips, music, email and electronic books etc have increased explosively. The information and content may today be provided from many different sources, and the variety and availability of content has increased substantially.

For example, the number of available television channels in most countries has increased substantially over the last decade, and in many countries, viewers can receive tens or even hundreds of different TV channels. The TV channels are further provided from different broadcasters and sources, and are communicated through a variety of media including terrestrial radio broadcasts, cable distribution or satellite broadcasts. Similarly, the number of available radio channels has increased explosively and are provided through different media such as satellite broadcasts, digital terrestrial broadcasts, cable distribution or even through the internet. Furthermore, available content may be provided in real time format, through for example broadcasts. Content may also be provided from non-broadcast related storage like CD (CD-DA), Video CD, DVD-Video etc. Furthermore, the proliferation of electronic communication have led to the distribution and exchange of increasing numbers of electronic content items such as electronic books, email, documents, audio files etc.

In addition, available facilities for electronically storing content have increased substantially. For example, hard disk based Personal Video Recorders (PVRs) have emerged that are capable of storing large quantities of recorded content items. Content items may furthermore be stored on removable storage mediums in for example DVD based recorders. There is furthermore a trend for consumer equipment related to different types of content items to merge together. Specifically, it is expected that central entertainment equipment capable of supporting many different applications associated with different content will become increasingly prevalent. It is expected that such equipment may comprise functionality for supporting content items including music, video, email, games etc.

As the amount of available content items and storing facilities have increased substantially, it has become increasingly difficult for a user to organize and locate specific content items. Typically, the user manually stores content items in a hierarchical structure. For example, a personal computer may comprise a structure of hierarchical folders created by the user for organizing and grouping content items.

However, as the amount of available content items, content sources and storage has increased explosively, this method of organizing content items has become increasingly complex, time consuming, cumbersome and impractical. In addition, content items may be difficult to find for example if a content item by mistake has been put in the wrong group. Furthermore, the approach is not suitable for retaining a consistent categorization principle as it relies on a user or users being aware of and consistently using the same principles for grouping content items.

Consequently, an improved system for grouping or classification of content items would be advantageous.

Accordingly, the Invention seeks to mitigate, alleviate or eliminate one or more of the above mentioned disadvantages singly or in any combination.

According to a first aspect of the invention, there is provided a method of grouping content items for at least one user comprising the steps of: determining a grouping category scheme used by the at least one user in response to a grouping by the at least one user of content items; determining a content item grouping principle used by the at least one user in response to the grouping by the at least one user of content items and the grouping category scheme; determining a classification characteristic of a first content item; grouping the first content item with other content items in response to the content item grouping principle and the content classification characteristic.

The steps of determining the grouping category scheme and the content item grouping principle is preferably in response to an automatic analysis of a grouping of previously grouped content items. The automatic analysis may analyze which categories the content items have been grouped into, and the content items of each category may be analyzed to determine one or more common characteristics.

The invention allows an automatic grouping of content items based on an existing content item grouping principle. Hence, a user may initially manually group content items in accordance with a given content item grouping principle. This grouping principle may be determined and used for automatically determining an appropriate grouping of new content items. Hence, the invention allows for an improved grouping of content items which is easy to use, has low complexity, requires little or no manual invention, provides a low probability of erroneous grouping, is easy to implement and/or which automatically adapts to a preferred grouping principle of a user or users. The invention allows for a system of grouping which requires no manual setup of categories or rules for a grouping. Rather the invention enables a grouping system that automatically learns from and adapts to an existing grouping principle used by a user.

The invention may be applied in response to only one user. However, it may also be used to group content items for a plurality of users. For example, the content item grouping principle may be determined in response to only a first user and the grouping of content items by other users may be in accordance with the content grouping principle of the first user. This may allow for a plurality of users to group content items in accordance with the content item grouping principle of a first user without specifically knowing the content item grouping principle.

The content item grouping principle may comprise any suitable principle, rule, characteristic, grouping category scheme and/or preference that may assist a grouping of content items. Hence, the content item grouping principle need not be a specific rule for how to allocate all possible content items but may consist in any indication that may provide an indication of a preferred grouping of one or more content items. Furthermore, the classification characteristic may be any suitable characteristic that may allow grouping of the first content item relative to the content item grouping principle. The content items may for example be one or more of audio clips, video clips, pictures, emails, electronic documents, programs, games, broadcast programs etc.

According to a feature of the invention the step of determining content item grouping principle comprises determining group content item characteristics and the step of grouping comprises comparing the content classification characteristic with the group content item characteristics. The group content item characteristic may be a characteristic of all content items that are classified together in a group, such as the same artist, title, origin etc. This allows for an efficient and easy to implement method for grouping new content items.

According to a different feature of the invention, the classification characteristic comprises metadata associated with the content item. For content items having associated metadata this provides a particular easy and reliable method of determining a classification characteristic. The metadata may for example relate to an author or time of creation of the associated content clip.

According to a different feature of the invention, the classification characteristic is determined in response to a content analysis of the content item. The content analysis may derive a characteristic of the content item which for example may be compared to corresponding characteristics in the content item grouping principle of already grouped content items. This allows for efficient grouping based only on the content of the content items and thus does not require additional data or characteristics of the content item to be known.

According to a different feature of the invention, the classification characteristic comprises a keyword characteristic. For example, for a text based content item a keyword search may be performed and compared to keywords comprised in the content item grouping principle for associated groups. It thus provides for a simple implementation with reliable performance.

According to a different feature of the invention the classification characteristic comprises a classification characteristic determined by a second user. This allows for classifications by other users to be used in the content item grouping. This is particularly useful when the method is applied to an apparatus shared by users.

According to a different feature of the invention, the first content item is received from a source and the classification characteristic comprises a source characteristic. For example, the grouping may be in response to a location from which the content item was received. This allows for a suitable grouping that will be advantageous in many applications.

According to a different feature of the invention, the first content item is an email content item, an audio content item and/or is a video content item. The method thus provides an easy to use, simple and efficient for grouping audiovisual and text based content items.

According to a different feature of the invention, the step of grouping further comprises receiving a user input and the grouping of the first content item is further in response to the user input. This allows for increasing flexibility and user control over the grouping. Specifically, a grouping recommendation may be provided by the method and the user input may be accepted or overridden this recommendation.

According to a different feature of the invention, the method further comprises the step of updating the content item grouping principle in response to the grouping of the first content item. This allows for the grouping of content items to be continually improved and updated in order to suit the current preferences and/or to be continually refined to more accurately reflect the user's preferred grouping principle. This is particularly useful if the grouping comprises receiving a user input related to a preferred grouping of the first content item. Such a user input may for example be for a confirmation or rejection of the grouping determined by the method for the first content item.

According to a second aspect of the invention, there is provided an apparatus for grouping content items for a user comprising: means for determining a grouping category scheme used by the at least one user in response to a grouping by the at least one user of content items; means for determining a content item grouping principle used by the user in response to the grouping by the user of content items and the grouping category scheme; means for determining a classification characteristic of a first content item; means for grouping the first content item with other content items in response to the content item grouping principle and the content classification characteristic.

These and other aspects, features and advantages of the invention will be apparent from and elucidated with reference to the embodiment(s) described hereinafter.

Embodiments of the invention will be described, by way of example only, with reference to the drawings, in which

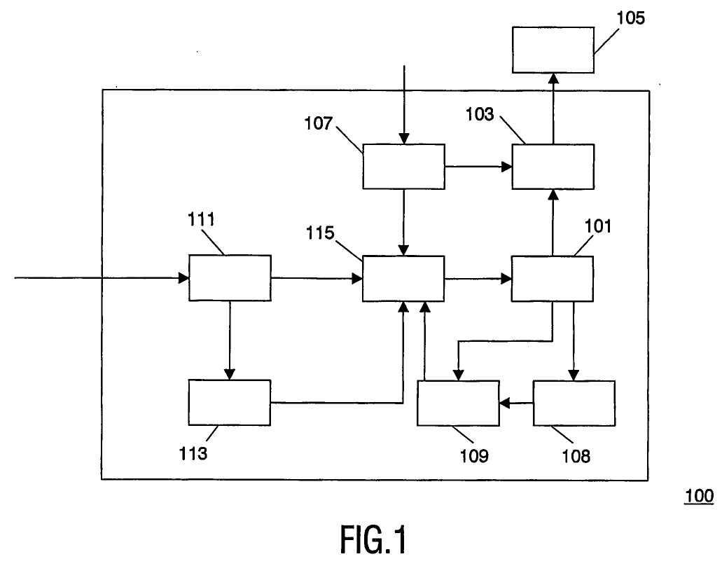

FIG. 1 illustrates an apparatus for grouping content items in accordance with an embodiment of the invention; and

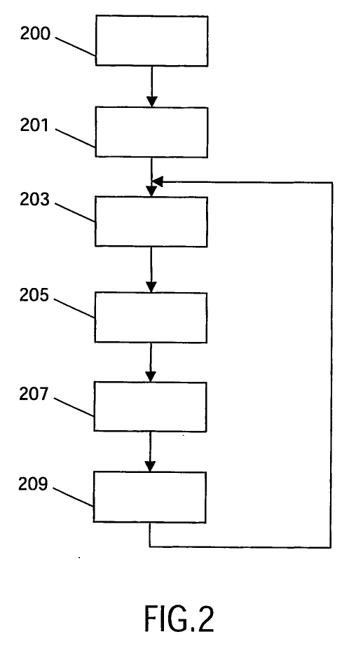

FIG. 2 illustrates a flowchart of a method for grouping content items in accordance with an embodiment of the invention.

The following description focuses on an embodiment of the invention applicable to a consumer equipment and in particular to a personal computer. However, it will be appreciated that the invention is not limited to this application but may be applied in many other embodiments involving grouping or categorization of content items.

FIG. 1 illustrates an apparatus for grouping content items in accordance with an embodiment of the invention. In the described embodiment, the apparatus is a general purpose personal computer 100, and FIG. 1 illustrates the functional modules that may be implemented in a computer in accordance with an embodiment of the invention. It will be clear to the person skilled in the art that the computer may comprise many other functional modules than those specifically illustrated in FIG. 1.

The computer 100 comprises a storage for storing the content items. Specifically, the storage is the local hard disk 101 of the computer 100. The hard disk 101 is coupled to a presentation controller 103 which is operable to retrieve content items from the hard disk 101. The presentation controller 103 is coupled to a presentation device 105, which is capable of presenting the content items to a user. The presentation device 105 may for example comprise a visual display and audio device, such as an amplifier and speakers, and is thus preferable suitable for presenting different types of content items including audio visual content items such as video clips, music clips, text based content items etc. The presentation controller 103 is further operable to show the organization of the stored content items thereby allowing a user to identify, locate and select a specific content item. In an embodiment, the presentation controller 103 is capable of retrieving and displaying information related to the folder structure of the hard disk thereby allowing the user to locate content items in response to the folders in which they are stored.

The presentation controller 103 is coupled to a user interface 107 which is operable to receive a user input. In an embodiment, the user interface 107 is coupled to a keyboard and mouse thereby allowing the user to control the operation of the computer 101. The presentation controller 103 is operable to receive inputs from the user interface 107 thereby allowing the user to control, arrange and select content items on the hard disk 101 as well as control characteristics of the presentation of these.

The hard disk is also coupled to a grouping category scheme processor 108 which is operable to determine a grouping category scheme used by the user to group content items. Specifically, the grouping category scheme processor 108 is operable to determine the categories used in terms of folders on the hard disk comprising content items.

The hard disk 101 is further coupled to a grouping principle processor 109 which is also coupled to the grouping category scheme processor 108. The grouping principle processor 109 is operable to determine a content item grouping principle used by the at least one user in response to the grouping category scheme and the grouping by the at least one user of content items. In an embodiment, the grouping principle processor 109 may sequentially process all folders of the hard disk comprised in the grouping category scheme and determine a common characteristic for content items in each folder. For example, it may determine that all content items in one folder are songs of a specific artist. It will then add this information to the content item grouping principle.

The computer 100 further comprises a content item receiver 111. The content item receiver 111 is operable to receive a content item from a suitable source. In the preferred embodiment, content items are received through a network connection such as the Internet or from a removable storage medium such as a Compact Disc or floppy disc. However, it will be apparent that content items may be received in any suitable way from any suitable origin or may for example already be stored in the apparatus.

The content item receiver 111 is coupled to a classification characteristic processor 113. The classification characteristic processor 113 is operable to determine a classification characteristic of a new content item received by the content item receiver 111. The classification characteristic may relate to one or more characteristics of the new content item, and it may further depend on the type of content item received. For example, a classification characteristic for a music audio file may comprise the composer, the artist performing and the title of the music. A classification characteristic for an electronic text document may for example comprise the author, title and creation date of the document.

The computer further comprises a grouping processor 115. The grouping processor 115 is coupled to the classification characteristic processor 113 and the grouping principle processor 109. The grouping processor 113 receives the content item grouping principle and the determined classification characteristic for the new content item and determines a suitable grouping for the new content item in response thereto.

In an embodiment, the grouping processor 115 simply compares the items of the classification characteristic to the information related to each folder in the content item grouping principle. The suitable grouping is then determined as the folder for which there is the closest match between the classification characteristic and the content item grouping principle information. The grouping processor 115 is furthermore coupled to the content item receiver 111 and the hard disk 101 and is operable to store the new content item on the hard disk 101 in response to the determined grouping of the new content item.

FIG. 2 illustrates a flowchart of a method for grouping content items in accordance with an embodiment of the invention. The method is applicable to the computer illustrated in FIG. 1 and will be described with reference to this.

In step 200, the grouping category scheme processor 108 determines a grouping category scheme in response to the grouping of content items already used by the user. Thus the grouping category scheme processor 108 determines which categories the user is dividing the content items into. Specifically, the grouping category scheme processor 108 analyses the hard disk to determine the folder structure used for storing the received content items.

In step 201, the grouping principle processor 109 determines the content item grouping principle for the content items currently stored on the hard disk based on the grouping category scheme. As an example, the computer may have been used for some time before the method is activated. Therefore the hard disk 101 may comprise a large number of content items that have been manually organized and grouped. Specifically, the user may have developed a folder structure for content items and allocated content items to individual folders. As an example, for music content items, the user may have allocated individual folders for music by his favorite artists. Other folders may be used for music which is not by his favorite artists, and these may comprise a plurality of folders each containing music of a specific genre.

In an embodiment, the grouping principle processor 109 scans the hard disk 101 and for each folder comprised in the grouping category scheme, it determines a number of predetermined characteristics. In another embodiment, the characteristics are determined on the basis of meta data associated with each content item. For example, MP3 music files comprise additional data information indicating the artist performing, the title of the clip and a genre of the music. The grouping principle processor 109 extracts this information from the stored files.

For music content items, the grouping principle processor 109 may thus consider the parameters of the artist, title and music genre. For each folder, it then determines if there are any parameters which appear to be common for all or most of the content items. Thus the grouping principle processor 109 preferably determines group content item characteristics. Hence, a general or prevalent characteristic of all or most of the content items in a specific group may be determined.

For example, the grouping principle processor 109 may determine that a parameter is associated with a folder if that parameter is common for more than e.g. 80% of the content items therein. Hence, for a folder used for music of a favorite artist, the grouping principle processor 109 will detect that more than 80% of the content items therein are by that artist, and it will therefore associate that artist with that folder. This association will then be included in the content item grouping principle.

As the grouping principle processor 109 scans the hard disk 101, it will thus gradually build up information related to the grouping principle that has been used by the user. Hence, in one simple embodiment, the content item grouping principle simply comprises a list of possible content item parameters and an associated folder. One example of a content item grouping principle derived in this way may be:

| Content Item Parameter | Folder |
|---|---|
| Artist = Artist A | C:/music/ArtistA |
| Artist = Artist B | C:music/ArtistB |
| Artist = Artist C | D:/MyDocuments/Video/ArtistC |
| Genre = Genre A | C:/music/GenreA |
| Artist = ArtistA and Genre = GenreA | C:/music/ArtistA |

In this example, the grouping principle processor 109 has detected that music which is of Artist A and Genre A is predominantly stored in C:/music/ArtistA and accordingly this folder has been determined for content items matching both these characteristics.

It will be understood that the above embodiments simply represent specific embodiments, and that any suitable content item grouping principle and method of determining a content item grouping principle may be used without detracting from the invention.

Step 201 is followed by step 203 wherein a new content item is received by the content item receiver 111. In a further embodiment, the content item is received by downloading the content item from the Internet, but in other applications, a content item may be selected for grouping in other ways. For example, a content item already stored on the hard disk may be selected for grouping, and in some embodiments, content items already grouped in the storage structure may be selected for re-grouping. This is particularly appropriate for situations where the content item grouping principle has changed.

Step 203 is followed by step 205 wherein the classification characteristics processor 113 determines a classification characteristic of the new content item. The classification characteristic allows a relation between the new content item and the current grouping of content items to be determined. It thus provides a means for associating the current item with information of the content item grouping principle.

In a further embodiment, the classification characteristic is determined as one or more characteristics of the new content item that correlate with information of the content item grouping principle. In another embodiment, meta data of the received content item is extracted. For similar types of content items, the information in the meta data is likely to refer to the same parameters. Therefore as a specific example, the new content item may be an MP3 audio file and the classification characteristic may be determined as the artist, title and genre of the music of the file.

Step 205 is followed by step 207 wherein the new content item is grouped with other content items in response to the content item grouping principle and the content classification characteristic. In a further embodiment, this is achieved by comparing the content classification characteristic with the group content item characteristics comprised in the content item grouping principle.

In the specific example given, the classification characteristics of the new content item comprising the artist, title and genre are compared to the contents of the content item grouping principle. Hence, the artist parameter of the new content item is compared to the information related to artists in the content item grouping principle, the title parameter of the new content item is compared to the information related to titles in the content item grouping principle and the genre parameter of the new content item is compared to the information related to genres in the content item grouping principle. The folder that provides the closest match is selected as the appropriate group for the content item. As a specific example, if the new content item has the classification characteristic artist=Artist A, folder C:/music/ArtistA will be selected.

It will be apparent that any suitable algorithm and principle of determining a correlation between the classification characteristic and the information of the content item grouping principle may be used including for example fuzzy based logic, pattern recognition or comparison metric algorithms.

Step 207 is followed by step 209 wherein the new content item is stored in the selected folder. In the embodiment illustrated in FIG. 2, the method then returns to step 203 in order to start categorization and grouping of the next content item.

However, in another embodiment, step 207 further comprises presenting the grouping determined by the grouping processor 115 to the user and receiving a user input in response. Specifically, the user input may either be a confirmation that the content item should be stored as determined or an instruction to override this recommendation. In the latter case, the user input preferably allows for a preferred folder to be determined, and specifically the user may directly enter another folder in which the content item should be stored. This allows for a method which assists and facilitates grouping but is not intrusive and allows for the user to retain full control of where individual content items are stored.

In a further embodiment, the method furthermore preferably comprises updating the content item grouping principle in response to the grouping of the content item and in particular in response to the user input. This allows for the content item grouping principle to be continually updated to reflect changes in the preferred grouping principles and/or improved accuracy of the determined content item grouping principle.

In other embodiments, the user may directly input information on the preferred grouping principle, and the content item grouping principle may be updated in response. For example, the user may directly indicate that all content items by Artist A should go into folder C:/music/GenreA.

For clarity and brevity, the above embodiment has in particular been described with reference to MP3 based music content items. However, it will be apparent that the principles are applicable to many other types of content items and combinations of types of content items.

For example, the described principles are applicable to email content items. Each email message comprises categorized information including the identity of the sender, the time of receipt, a priority, a subject field etc. Preferably, one or more of these parameters are considered for the classification characteristic and/or the content item grouping principle. For example many users group their received email messages into folders corresponding to the sender of the email, and the content item grouping principle and classification characteristic therefore preferably includes this information.

In some embodiments, the grouping may be determined directly on the basis of content analysis. For a simple content item type such as text based content items (e.g. email), a simple content analysis may comprise in a keyword search. Hence, the grouping principle processor 109 may analyze all emails in a folder and detect words that occur frequently (ignoring the frequently expected words such as “the”, “a” etc). When a new email is received, the classification characteristic processor 113 may extract potential keywords and the grouping processor 115 may compare these keywords to those included in the content item grouping principle. The appropriate folder may be selected as the one with the most keywords in common.

Content analysis may also be applicable to more complex types of content items. In recent years, significant research has been carried out in the field of content analysis for e.g. video or music signals and any of the developed methods or algorithms for content analysis may be used without detracting from the invention.

An example algorithm for content analysis is the detection of a video clip relating to a football game, which may be detected by a high concentration of the color green and a predominantly sideways movement of the picture. Indeed, highlights may be detected from the associated audio signal. Specifically, the occurrence of a goal may be detected as an increased volume of the background noise from the spectators. Thus, in this embodiment, the content analysis may be used to detect that a content item relates to a football game and should be grouped with other content items having similar characteristics.

Further information on content analysis is generally available to the person skilled in the art. For example, the articles “Content-Based Multimedia Indexing and Retrieval” by C. Djeraba, IEEE Multimedia, April-June 2002, Institute of Electrical and Electronic Engineers; “A Survey on Content-Based Retrieval for Multimedia Databases” by A. Yoshika et al., IEEE Transactions on Knowledge and Data Engineering, vol. 11, No. 1, January/February 1999, Institute of Electrical and Electronic Engineers; “Applications of Video-Content Analysis and Retrieval” by N. Dimitrova et al., IEEE Multimedia, July-September 2002, Institute of Electrical and Electronic Engineers and the therein included references provide an introduction to content analysis.

In some embodiments, the classification characteristic and/or the content item grouping principle may be determined by a different user than the user associated with the new content item. Hence, a first user may manually have categorized a number of content items and the content item grouping principle may be determined in response thereto, for example as described previously. This content item grouping principle may then be used for content items of a second user, and the classification characteristic may thus be determined by the second user. The grouping of the content item of the second user will therefore be according to the content item grouping principle of the first user. This allows for similar groupings of content items for different users, and therefore provides consistency in the grouping for different users thereby facilitating locating content items for a plurality of users.

The invention can be implemented in any suitable form including hardware, software, firmware or any combination of these. However, the invention can be implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. In addition, singular references do not exclude a plurality. Thus references to “a”, “an”, “first”, “second” etc do not preclude a plurality.

1. A method of grouping content items for at least one user comprising the steps of:
determining (200) a grouping category scheme used by the at least one user in response to a grouping by the at least one user of content items;
determining (201) a content item grouping principle used by the at least one user in response to the grouping by the at least one user of content items and the grouping category scheme;
determining (205) a classification characteristic of a first content item; and
grouping (207, 209) the first content item with other content items in response to the content item grouping principle and the content classification characteristic.

2. A method as claimed in claim 1 wherein the step of determining (201) the content item grouping principle comprises determining group content item characteristics and the step of grouping comprises comparing the content classification characteristic with the group content item characteristics.

3. A method as claimed in claim 1 wherein the classification characteristic comprises meta data associated with the content item.

4. A method as claimed in claim 1 wherein the classification characteristic is determined in response to a content analysis of the content item.

5. A method as claimed in claim 1 wherein the classification characteristic comprises a keyword characteristic.

6. A method as claimed in claim 1 wherein the classification characteristic comprises a classification characteristic determined by a second user.

7. A method as claimed in claim 1 wherein the first content item is received from a source and the classification characteristic comprises a source characteristic.

8. A method as claimed in claim 1 wherein the first content item is an email content item.

9. A method as claimed in claim 1 wherein the first content item is an audio content item.

10. A method as claimed in claim 1 wherein the first content item is a video content item.

11. A method as claimed in claim 1 wherein the step of grouping (207, 209) further comprises receiving a user input and the grouping of the first content item is further in response to the user input.

12. A method as claimed in claim 1 further comprising the step of updating the content item grouping principle in response to the grouping of the first content item

13. A computer program product for enabling the carrying out of a method according to claim 1.

14. An apparatus (100) for grouping content items for at least one user comprising:
means (108) for determining a grouping category scheme used by the at least one user in response to a grouping by the at least one user of content items;
means (109) for determining a content item grouping principle used by the at least one user in response to the grouping by the at least one user of content items and the grouping category scheme;
means (113) for determining a classification characteristic of a first content item; and
means (115) for grouping the first content item with other content items in response to the content item grouping principle and the content classification characteristic.
